(19) United States
(12) Patent Application Publication
(10) Pub. No.: US 2015/0145189 A1
(43) Pub. Date: May 28, 2015

(54) Shock-absorber and method for manufacturing a shock-absorber

(71) Applicant: CIKAUTXO, S.COOP., Berriatua (ES)

(72) Inventor: Iñaki AZPIAZU ECHAVE, Markina-Xemein (ES)

(73) Assignee: CIKAUTXO, S.COOP., Berriatua (ES)

(21) Appl. No.: 14/550,695

(22) Filed: Nov. 21, 2014

(30) Foreign Application Priority Data
Nov. 22, 2013 (ES) P201331710

(51) Int. Cl. F16F 3/093; B29C 70/68

(52) U.S. Cl. CPC F16F 3/093; B29C 70/68; B29K 2083/005
USPC 267/140.3; 264/255

(57) ABSTRACT

A shock-absorber suitable for joining a first component subjected to vibrations, such as a vehicle exhaust pipe, to a second component, such as a vehicle frame, and a method for manufacturing the shock-absorber. According to some implementations the shock-absorber is made of a first elastic material of a first density constituting a majority of the volume of the shock-absorber and a second elastic material of a second density less than the first density. The shock absorber includes a first area designed for being joined to the first component and a second area designed for being joined to the second component. The second elastic material at least partially covers the first area and is configured to at least partially contact the first component when the first component is assembled within the first area.

### CROSS-REFERENCE TO RELATED APPLICATIONS

This application relates to and claims the benefit and priority to Spanish Patent Application No. P201331710, filed Nov. 22, 2013.

### TECHNICAL FIELD

The disclosure relates to shock-absorbers capable of joining a first component subjected to vibrations to a second component. The disclosure also relates to the method for manufacturing the shock-absorbers.

### BACKGROUND

Shock-absorbers capable of joining a first component subjected to vibrations, such as a vehicle exhaust pipe, for example, to a second component, such as a vehicle frame, for example, are known. These shock-absorbers are usually made of rubber and must be rigid enough to withstand the static loads to which it is subjected, such as the weight of the first component, for example, which usually hangs from the shock-absorber. However, the greater the rigidity of the shock-absorber the lower the vibration damping power, i.e., the more rigid the shock-absorber is, the more vibrations it will transmit. To solve this problem, shock-absorbers comprising a complex shape to reduce some areas and thus reduce the total rigidity of the shock-absorber are known.

Likewise, rubber shock-absorbers internally comprising a metal insert are also known, for example, a steel or an aluminum insert, with greater density than the rubber insert, such that it provides an increase in the total rigidity of the shock-absorber.

In this manner, JP2010210015 A discloses a shock-absorber for hanging an exhaust pipe (first component) which is subjected to vibrations for joining it to a vehicle frame (second component). The shock-absorber comprises a base body comprising a first area designed for being joined to the first component and a second area designed for being joined to the second component. The base body is made of rubber and internally comprises an embedded metal insert. When the shock-absorber is subjected to static and dynamic loads, the base body made of rubber is deformed, tending to become longer. The metal insert comprises a series of curvatures which tend to be aligned when the base body is deformed, which allows the insert to deform. When the deformation of the metal insert reaches a limit, it changes into a rigid body preventing the plastic deformation of the base body.

### SUMMARY OF THE DISCLOSURE

According to some implementations a shock-absorber suitable for joining a first component subjected to vibrations, such as a vehicle exhaust pipe, to a second component, such as a vehicle frame is provided. The shock-absorber comprises a first area which is designed for being joined to the first component and a second area designed for being joined to the second component. The shock-absorber also comprises a first elastic material covering a large part of the volume of the shock-absorber and a second elastic material of a lower density located at least in the first area. The second material at least partially contacts the first component.

Vibration transmission from the first component, such as a vehicle exhaust pipe, to the second component, such as a vehicle frame, is significantly reduced by the shock absorber in a simple, economical and effective manner, it not being necessary to provide the shock-absorber with complex shapes for reducing the total rigidity. At the same time, an excessive increase in the density or total volume of the shock-absorber is prevented, which would be counterproductive for minimizing vibration transmission.

Additionally, assembling operations in assembly lines are also made easier because at least the first component is inserted in a non-rigid area, which makes the operation of inserting the first component into the first area easier.

These and other advantages and features of the will become evident in view of the drawings and the detailed description of the invention.

### BRIEF DESCRIPTION OF THE DRAWINGS

FIG. 1A shows a front view of a shock-absorber according to one implementation.

FIG. 1B shows a section view according to cross section I-I of the shock-absorber of FIG. 1A.

FIG. 2A shows a perspective view of a shock-absorber according to another implementation.

FIG. 2B shows a front view of the shock-absorber of FIG. 2A.

FIG. 2C shows a section view according to cross section II-II of the shock-absorber of FIG. 2B.

FIG. 2D shows a longitudinal section view of a shock-absorber according another implementation.

FIG. 2E shows the shock-absorber of FIG. 2C together with a graphical depiction of the first component and the second component.

### DETAILED DESCRIPTION

According to the implementations disclosed herein, a shock-absorber 1 is provided that is suitable for joining a first component 2 subjected to vibrations to a second, preferably static, component 3. The shock-absorber 1 includes a first area 5 which is designed for being joined to the first component 2 and a second area 6 designed for being joined to the second component 3. The shock-absorber 1 also includes a first elastic material 4a covering a large part/majority of the volume of the shock-absorber 1 and a second also elastic material 4b but of a lower density located at least in the first area 5. The second material 4b at least partially contacts the first component 2.

The first material 4a comprises a density and geometry that provides the shock-absorber 1 with sufficient rigidity so that it can withstand the static loads to which it is subjected without exceeding its elastic limit. This material, as seen in the drawings, covers a majority of the volume of the shock-absorber 1. For damping the vibrations that can be transmitted by the first component 2, which is subjected to vibrations, the shock-absorber is provided with a second material 4b capable of absorbing the vibrations. Therefore, the shock-absorber 1 comprises a second elastic material 4b, the density of which is less than the density of the first material 4a, arranged such that the second material 4b contacts the first component 2.

The shock-absorber 1 is therefore rigid enough to withstand the static loads to which it is subjected, and flexible enough (where required) to stop vibration transmission from the first component 2 to the second component 3.

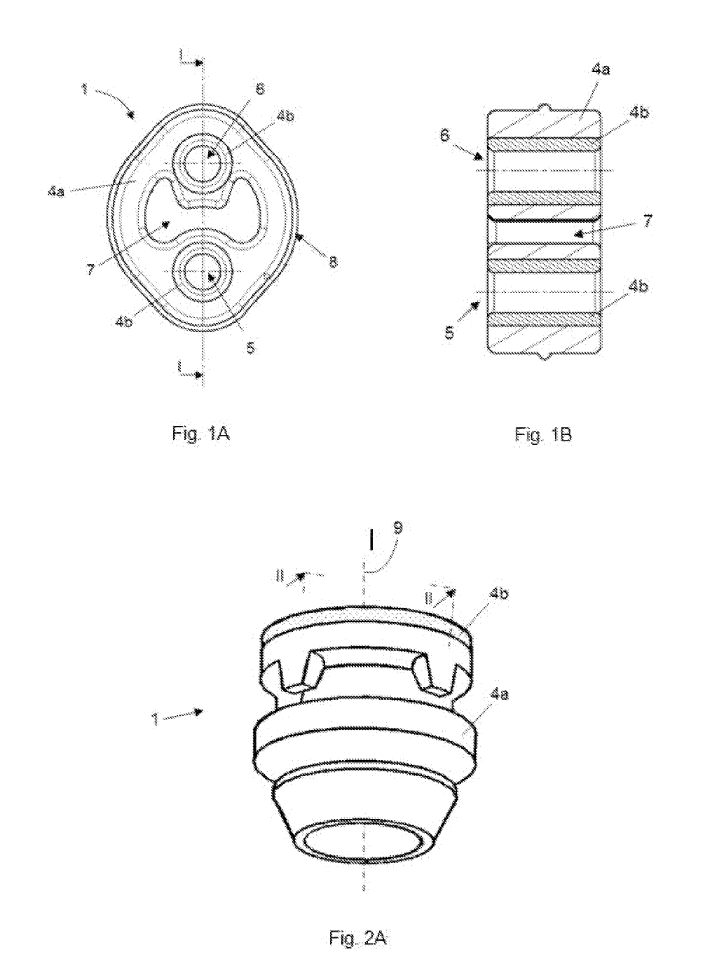

In this sense, FIG. 1A shows a front view of a shock-absorber 1 according to one implementation. The shock-absorber 1 according to this example is suitable for joining a first component 2 subjected to vibrations, such as the gas discharge pipe of a vehicle combustion engine (such as an exhaust pipe), not shown in the drawings, to a second component 3, such as a fixed element of a vehicle frame or sub-frame. In the example of FIG. 1A, the first component 2, for example, the exhaust pipe, hangs from the shock-absorber 1 and the shock-absorber 1 in turn hangs from the second component 3 so the shock-absorber 1 preferably works under traction. In the implementation of FIG. 1A the outer contour 8 of the shock-absorber 1 may comprise a substantially oval-shaped section, the outer contour 8 may be formed by the first material 4a.

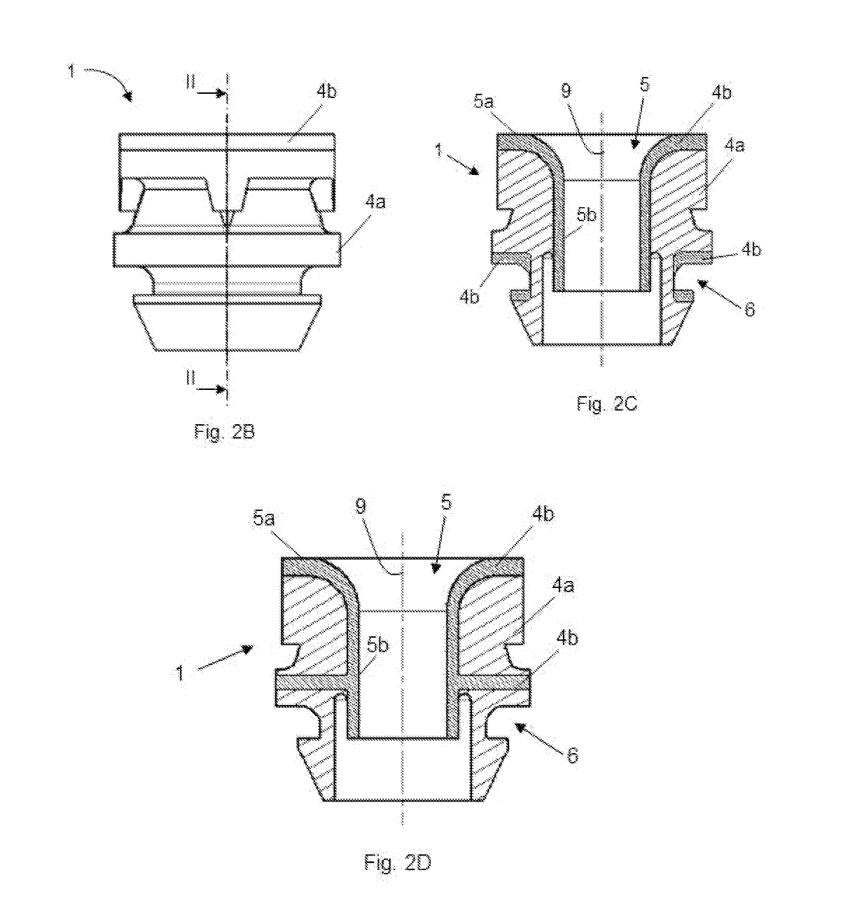

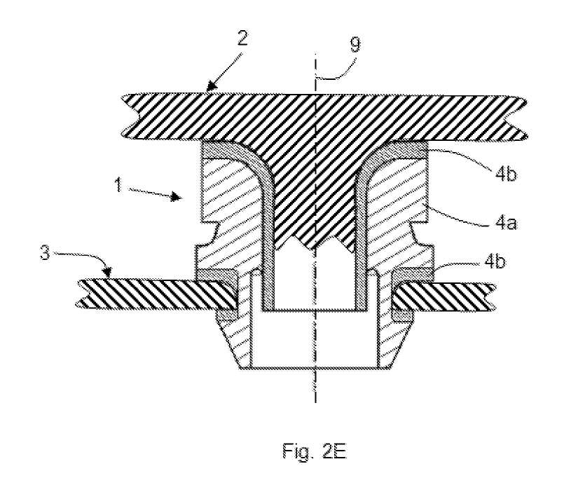

FIG. 2A shows a perspective view of a shock absorber 1 according to another implementation. The shock-absorber 1 is suitable for joining a first component 2 subjected to vibrations, such as a vehicle radiator, to a second component 3, such as a fixed element of the vehicle frame or sub-frame. In the example of FIG. 2A, the first component 2, for example the radiator, is guided into and supported on the shock-absorber 1 and the shock-absorber 1 is in turn joined to the second component 3 such that it rests on the second component 3, so the shock-absorber 1 preferably works under compression. The shock-absorber 1 may comprise a shape that resembles a part of revolution or a prism having a rectangular, quadrangular, circular, elliptical, oval-shaped section, etc., comprising a longitudinal axis 9, the first area 5 extending around the longitudinal axis 9. In the non-limiting example of FIG. 2C, the shock-absorber 1 comprises a shape of revolution having a substantially circular section where the axis of revolution coincides with the longitudinal axis 9.

With respect to some of the implementations disclosed herein, the density of the second material 4b is preferably less than or equal to 1 g/cm³, and the sum of densities of the first material 4a and the second material 4b is preferably less than or equal to 2 g/cm³. In this manner, the shock-absorber 1, on one hand, is robust enough so that it can withstand the static loads to which it is subjected without exceeding its elastic limit, and on the other hand, is flexible enough so as to minimize or prevent vibration transmission from the first component 2, which is subjected to vibrations and joined to the first area 5, to the second component 3 which is attached to the second area 6. However, to even further optimize vibration absorption, non-rigid areas (made up of the second material 4b) locally distributed in the shock-absorber 1 are added. Therefore, it is not necessary for the shock-absorber 1 to comprise complex shapes which aid in reducing the total rigidity thereof, nor does the density or the total volume of the shock-absorber 1 increase excessively, which would be counterproductive for minimizing vibration transmission. The greater the rigidity of the shock-absorber the lower the vibration damping power, i.e., the greater the density the more rigid the shock-absorber will be, and the more rigid the shock-absorber 1 is, the more vibrations it will transmit..

Examples of the first material 4a can be EPDM (ethylene-propylene-diene monomer), natural rubber, thermoplastic or the like and examples of the second material 4b can be silicone sponge, EPDM sponge, polyurethane sponge or the like. According to some implementations the first material 4a of the shock-absorber 1 is preferably EPDM and the second material 4b is preferably silicone sponge that is over-molded onto the first material 4a in a liquid form.

The main material of the shock-absorber 1 is the first material 4a covering most/majority of the volume of the shock-absorber 1 and comprising such a density that it provides sufficient rigidity so that the shock-absorber 1 can withstand the static loads to which it is subjected without exceeding its elastic limit. A second material 4b of less density also forms a part of the shock-absorber and is coupled to the first material 4a. The objective of using the second material 4b is not to reinforce the first material 4a but rather to provide flexible areas capable of absorbing the vibrations that may be transmitted by the first component 2 which is subjected to vibrations. To achieve this effect effectively, the second material 4b is arranged in the first area 5 such that the second material 4b at least partially contacts the first component 2, as seen in the examples of FIGS. 1B and 2C. This configuration also makes assembling operations easier because at least the first component 2 is inserted into a non-rigid area, which makes the operation of inserting the first component 2 into the first area 5 easier.

Optionally, the second area 6 of the shock-absorber 1 can also comprise the second material 4b, as seen in FIGS. 1A and 1B, for further damping the vibrations transmitted by the first component 2. In this example, the second material 4b is arranged in the second area 6 such that the second material 4b also at least partially contacts the second component 3.

In the implementation of FIG. 2D, the second material 4b of the second area 6 is not arranged such that the second material 4b contacts the second component 3, but is arranged in an area close to or adjacent to the second area 6, preferably arranged between the first area 5 and the second area 6.

It is also possible to include in any of the implementations a third area, or a strip, formed by the second material 4b which is arranged in an intermediate area between the first area 5 and the second area 6, for example.

Usually, the first component 2 which is subjected to vibrations tends to comprise a protuberance in the form of a shaft, or coupling means, for being able to be coupled or attached to the shock-absorber. The first area 5 of the shock-absorber 1 according to any of the implementations may thus comprises a hole, which may have a circular section, enabling attachment with the first component 2. At least part of the second material 4b is arranged inside the hole, the second material 4b comprising a central hole which allows inserting the protuberance or coupling means of the first component 2. The first component 2 therefore directly contacts the second material 4b along at least a portion or the entire contact area between the first component 2 and the shock-absorber 1. In the example of FIGS. 1A and 1B, the second material 4b, located in the first area 5, comprises the shape of an elongated ring or a bushing.

The second area 6 of the implementation of FIGS. 1A and 1B also comprises a hole, preferably having a circular section, enabling attachment with the second component 3. The second material 4b is also arranged inside the hole, the second material 4b comprising a central hole which allows inserting the second component 3. The second component 3 also therefore directly contacts the second material 4b along at least a portion of or the entire contact area between the second component 3 and the shock-absorber 1.

The first area 5 and the second area 6 of the shock-absorber 1 of FIGS. 1A and 1B are arranged such that they are aligned with and facing one another. The first component 2 (a vehicle exhaust pipe, for example) which is joined to the shock-absorber 1 through the first area 5 can therefore be hung from the shock-absorber 1. In turn, the shock-absorber 1 can be suspended from the second component 3 (a vehicle frame, for example) which is joined to the shock-absorber 1 through the second area 6, such that the exhaust pipe (first component 2) is kept attached to the frame (second component 3) through the shock-absorber 1 which, in the embodiments of FIGS. 1A and 1B, is suitable for preferably working under traction, such that a controlled deformation of the shock-absorber 1 is achieved when in use, without the deformation ever exceeding a limit level, not even when the shock-absorber 1 losses the initial properties due to material aging over time.

Likewise, the first area 5 and the second area 6 of the shock-absorber 1 of FIGS. 1A and 1B may be separated by a hollow area. The inclusion of a hollow area 7, which is not required, also contributes to prevent vibrations from propagating through the shock-absorber 1 and in turn it also allows the first area 5 and the second area 6 to move away from one another more easily due to the elastic deformation when the shock-absorber 1 is subjected to static loads.

In the examples of FIGS. 2A, 2B, 2C, 2D and 2E, the second area 6 is an opening, preferably in the form of a notch, at least part of the second material 4b being arranged inside the opening such that the second material 4b covers the opening, or as can be seen in FIG. 2D in a section or an area not visible to the user and close to the second area 6. In the implementations of FIGS. 2A-2D, the opening/notch in the second area 6 is arranged in a direction substantially perpendicular to the longitudinal axis 9 of the shock-absorber 1 and it is joined to the frame (second component 3) through the notches of the area 6, as schematically shown in FIG. 2E. In contrast, the vehicle radiator (first component 2) which is subjected to vibrations is supported on the shock-absorber 1, therefore the shock-absorbers 1 of FIGS. 2A-2E are suitable for preferably working under compression. To prevent the first component (e.g. radiator) from being able to move on the shock-absorber 1, the radiator is entered or guided into the first area 5, as schematically shown in FIG. 2E. The support area 5a and guide area 5b of the shock-absorber 1 are made up of the second material 4b, therefore, the first component 2 directly contacts the second material 4b in the entire contact area between the first component 2 and the shock-absorber 1. The support area 5a of the first area 5 is substantially perpendicular to the longitudinal axis 9 and to the guide area 5b, which extends along the longitudinal axis 9, as seen in FIGS. 2C and 2D. The second area 6 is preferably arranged below the support area 5a of the first area 5.

According to any of the implementations disclosed herein, the second material 4b may be over-molded on the first material 4a in a manner as described below, a single part with two different elastic materials being obtained. According to some implementations a chemical binding is made between the first material 4a and the second material 4b. Other types of attachments are also possible.

According to one implementation, in a first step the first material 4a is obtained by molding or extruding a first elastic material, or by a similar method. The product obtained in this first step is used as an insert in a subsequent molding step where the insert is introduced in the cavity of a mold to then pour or inject the second material 4b onto the first material 4a.

As mentioned above, the second material 4b may be silicone sponge, which comprises a base component that is in liquid form and is mixed with a reagent in a mixing step. In the molding step, the mixture obtained is poured or injected into the cavity of the mold, where the insert formed by the first material 4a has been previously placed, such that the mixture expands and fills the gap existing between the insert and the cavity of the mold in a curing step. Since the base component is in a liquid state, it makes pouring the mixture into the mold easier, not requiring specific specializes equipment for pouring or injecting the mixture into the mold. This operation can even be performed manually. When the curing step ends, the shock-absorber 1 is removed from the mold in a removal step.

The second material 4b may adopt the desired color and texture and to that an additive, e.g. a dye, is added to the mixture in the mixing step before being poured or injected into the cavity of the mold. Both the first material 4a and the second material 4b can thus be of the same color giving the impression that the shock-absorber 1 is made only of a single material, or can be of different colors such that the shock-absorber 1 can acquire a distinctive look.

According to any of the implementations, the first area 5 and/or the second area 6 can comprise at least one protuberance to make the adhesion of the second material 4b on the first material 4a easier, there being provided not only a chemical binding but also a mechanical attachment.

Accordingly, a shock-absorber 1 may be manufactured in a fast and economical manner.

What is claimed is:

1. A shock-absorber for attaching a first component subjected to vibrations to a second component, the shock-absorber comprising:
a first elastic material of a first density constituting a majority of the volume of the shock-absorber,
a second elastic material of a second density less than the first density,
a first area designed for being joined to the first component, the second elastic material at least partially covering the first area and configured to at least partially contact the first component; and
a second area designed for being joined to the second component.

2. A shock-absorber according to claim 1, wherein the second density is less than or equal to 1 g/cm³.

3. A shock-absorber according to claim 2, wherein the sum of the first density and the second density is less than or equal to 2 g/cm³.

4. A shock-absorber according to claim 3, wherein the first elastic material is selected from the group consisting of: EPDM, natural rubber and thermoplastic.

5. A shock-absorber according to claim 2, wherein the second elastic material is selected from the group consisting of: silicone sponge, EPDM sponge and polyurethane sponge.

6. A shock-absorber according to claim 1, wherein the second elastic material is over-molded on the first elastic material.

7. A shock-absorber according to claim 3, wherein the second elastic material is over-molded on the first elastic material.

8. A shock-absorber according to claim 1, wherein the first area comprises a first opening configured to receive in a supporting fashion at least a portion of the first component, at least a part of the second elastic material being arranged inside the first opening so that when the shock-absorber is assembled with the first component the first component is only capable of making contact with the second elastic material.

9. A shock-absorber according to claim 1, wherein the first area comprises a first opening having a length and configured to receive in a supporting fashion at least a portion of the first component, at least a part of the second elastic material being arranged to cover an inner surface of the opening along substantially the entire length of the opening.

10. A shock-absorber according to claim 1, wherein the second area comprises a second opening configured to receive in a supporting fashion at least a portion of the second component, at least a part of the second elastic material being arranged inside the opening so that when the shock-absorber is assembled with the second component the second component is only capable of making contact with the second elastic material.

11. A shock-absorber according to any of claim 1, wherein the second area comprises a notch configured to receive in a supporting fashion at least a portion of the second component, at least part of the second elastic material being arranged inside the notch.

12. A shock-absorber according to claim 1, wherein a hollow area is disposed between the first area and the second area.

13. A shock-absorber according to claim 1, wherein an outer contour of the shock-absorber is formed by the first elastic material.

14. A shock-absorber according to claim 1, wherein the shock-absorber works under traction.

15. A shock-absorber according to claim 1, wherein the shock-absorber comprises an elongated shape comprising a longitudinal axis, at least part of the first area extending around the longitudinal axis.

16. A shock-absorber according to claim 15, wherein the second area is arranged in a direction substantially perpendicular to the longitudinal axis.

17. A shock-absorber according to claim 15, wherein the shock-absorber works under compression.

18. A shock-absorber according to claim 6, wherein the first area and/or the second area comprise at least one protuberance that increases an adhesion between the first and second elastic materials.

19. A method for manufacturing a shock-absorber according to claim 1 comprising:
molding or extruding the first elastic material to form a first part of the shock-absorber,
placing the first part in a cavity of a mold to function as an insert; and
over-molding the second elastic material on at least a portion of the insert to form a second part of the shock-absorber.

20. A method according to claim 19, wherein over-molding the second elastic material on at least a portion of the insert comprises:
forming a mixture by mixing a liquid base component of the second elastic material with a reagent; and
pouring or injecting the mixture into the cavity of the mold where the insert has been previously placed.

21. A method according to claim 20, further comprising curing the mixture so that the mixture expands and fills the gap existing between the insert and the cavity of the mold.

22. A method according to claim 20, wherein a dye is added to the mixture before being poured or injected into the cavity of the mold.
